(19) United States
(12) Patent Application Publication
(10) Pub. No.: US 2010/0235469 A1
(43) Pub. Date: Sep. 16, 2010

(54) Method And System For Providing Access To Resources Related To A Locatable Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/401,706

(22) Filed: Mar. 11, 2009

(51) Int. Cl. G06F 15/16

(52) U.S. Cl. 709/219

(57) ABSTRACT

Methods, systems and computer program products are described for providing access to resources related to a locatable resource, where the system includes a content handler component configured to receive a resource domain identifier included in a resource locator for a first resource. The resource locator identifies a resource provider of the first resource and the resource domain identifier identifies a resource domain of the resource provider. An accessor generator component is configured to generate a Uniform Related Resource Accessor (URRA) for accessing a second resource related to the first resource. The URRA includes the resource domain identifier, and identifies an association between the second resource and the resource domain. A message formatter component is configured to generate a message including the URRA, and a content manager component is configured to send the message to a related resource service maintaining the association between the second resource and the resource domain.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

A Uniform Resource Identifier (URI) is a compact string of characters used to identify or name a resource. The main purpose of this identification is to enable interaction with representations of the resource over a network, typically the Internet, using specific protocols. A URI can be classified as a locator, a name, or both. URIs and their subsets, Uniform Resource Locaters (URLs) and Uniform Resource Names (URNs), have been invaluable in the growth of the web.

A URL is a URI that, in addition to identifying a resource, provides a means of acting upon or obtaining a representation of the resource by describing its primary access mechanism or network “location”. A URN is a URI that can be used to identify a resource without necessarily implying its location or how to reference it. For example, the URN “ISBN:0-395-36341-1” is an identifier that, like an international standard book number (ISBN), allows one to identify, but not locate, a book. In other examples, a URN can be in the form or a URL that identifies and locates a resource.

URIs are defined by schemes defining a specific syntax and can identify associated protocols. A URI scheme is the top level of the URI naming structure. Conventional URIs are formed with a “scheme name” portion followed by a colon character, and the remainder of the URI, which is called the “hierarchical part” in the current Internet Standard STD 66 and the Internet engineering task force (IETF) RFC 3986. The syntax and semantics of the hierarchical part are left largely to the specifications governing individual schemes, subject to certain constraints.

The basic syntax for a URI is:

<scheme>:<hierarchical-part>

This basic syntax of the “hierarchical part” is quite flexible, allowing for information related to identifying a host to access the resource identified by the URI, address information, relative path, parameter, and query information. For example, a syntax that further details the hierarchical part of a URL can be:

<scheme>://<host><path>?<query>

In some cases, a locatable resource can be associated with other resources related to the information in the locatable resource. Such related resources, for example, can include metadata of the locatable resource and services that use the locatable resource. For instance, metadata related to a digital image resource can describe the capture settings for the image, and metadata related to a digital music file resource can be a song title and artist name. In some cases, metadata can be embedded in the locatable resource, and in other cases, it can be included in, or can be, a separate resource from the locatable resource to which the information is related.

Accordingly, while a URL of a resource is useful for identifying and locating the locatable resource, the URL provides little, if any, assistance in identifying and/or accessing resources related to the locatable resource. This is particularly true when the related resource is a separate resource from the locatable resource.

### SUMMARY

Methods, systems and computer program products are described for providing access to resources related to a locatable resource. The methods, systems, and computer program products provide a generalized means for accessing resources, such as metadata, related to a locatable resource based on an identifier for locating the locatable resource. In an aspect, at least a portion of a URL for a locatable resource is used as an accessor for providing access to one or more resources related to the locatable resource.

In an aspect, a method and a computer readable medium storing a computer program, executable by a machine, for providing access to resources related to a locatable resource includes and comprises executable instructions for receiving a resource domain identifier included in a resource locator for a first resource, the resource locator identifying a resource provider of the first resource and the resource domain identifier identifying a resource domain of the resource provider. A Uniform Related Resource Accessor (URRA) is generated for accessing a second resource related to the first resource. The URRA includes the resource domain identifier, and identifies an association between the second resource and the resource domain of the resource provider of the first resource. A message including the URRA for accessing the second resource is generated and sent to a related resource service maintaining the association between the second resource and the resource domain.

In another aspect of the subject matter disclosed herein, a method and a computer readable medium storing a computer program, executable by a machine, for providing access to resources related to a locatable resource includes and comprises executable instructions for receiving, by a related resource service node (RRSN) representing a service domain, a message including a URRA. The URRA includes a resource domain identifier, which identifies a resource domain of a resource provider of a first resource, and identifies an association between a second resource and the resource domain. The method also includes determining whether the resource domain identified by the resource domain identifier in the URRA is at least partially included in the service domain represented by the RRSN; and processing the message when the resource domain is determined to be at least partially included in the service domain, the processing including providing access to the second resource.

In another aspect of the subject matter disclosed herein, a system for providing access to resources related to a locatable resource includes a content handler component configured to receive a resource domain identifier included in a resource locator for a first resource. The resource locator identifies a resource provider of the first resource and the resource domain identifier identifies a resource domain of the resource provider. An URRA generator component is configured to generate a URRA for accessing a second resource related to the first resource. The URRA includes the resource domain identifier, and identifies an association between the second resource and the resource domain. A message formatter component is configured to generate a message including the URRA, and a content manager component is configured to send the message to a related resource service maintaining the association between the second resource and the resource domain.

In another aspect of the subject matter disclosed herein, a system for providing access to resources related to a locatable resource includes a routing layer component in a RRSN representing a service domain, the routing layer configured to receive a message including a URRA including a resource domain identifier, which identifies a resource domain of a resource provider of a first resource, and identifying an association between a second resource and the resource domain. The system also includes a domain manager component configured to determine whether the resource domain identified by the resource domain identifier in the URRA is at least partially included in the service domain represented by the RRSN; and a processing agent component configured to process the message when the resource domain is determined to be at least partially included in the service domain, the processing including providing access to the second resource.

### BRIEF DESCRIPTION OF THE DRAWINGS

Advantages of the subject matter claimed will become apparent to those skilled in the art upon reading this description in conjunction with the accompanying drawings, in which like reference numerals have been used to designate like elements, and in which:

FIG. 1 is a flow diagram illustrating a method for providing access to resources related to a locatable resource according to an exemplary embodiment;

FIG. 2 is a block diagram illustrating a system for providing access to resources related to a locatable resource according to an exemplary embodiment;

FIG. 3 is a block diagram illustrating another system for providing access to resources related to a locatable resource according to another exemplary embodiment;

FIG. 4 is a block diagram illustrating another system for providing access to resources related to a locatable resource according to yet another exemplary embodiment;

FIG. 5 illustrates a network in which a system for providing access to resources related to a locatable resource can be implemented;

FIG. 6 illustrates another network in which a system for providing access to resources related to a locatable resource can be implemented;

FIG. 7 is a flow diagram illustrating another method for providing access to resources related to a locatable resource according to another exemplary embodiment;

FIG. 8 is a block diagram illustrating a system for performing the method of FIG. 7 according to an exemplary embodiment;

FIG. 9 is a block diagram illustrating a system for providing access to resources related to a locatable resource according to another exemplary embodiment; and

FIG. 10 is a block diagram illustrating an exemplary hardware device in which the subject matter disclosed herein may be implemented according to another embodiment.

### DETAILED DESCRIPTION

The subject matter presented herein provides for accessing resources related to a locatable resource based on an identifier for locating the locatable resource. Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an embodiment, a resource locator for a first resource includes a resource domain identifier that identifies a resource domain of a resource provider of the first resource. A resource locator is an identifier for locating a resource. Such a resource locator can be, in an embodiment, a URL of the first resource. The URL can be considered to be a URN for a related resource or a node configured to provide access to the related resource and the URL can be considered to be a new type of URL that serves as a locator by identifying a network path to the related resource or the node configured to provide access to the related resource. A related resource accessor for accessing a second resource related to the first resource is generated, in an embodiment, based on the first resource's resource locator, e.g., URL. The accessor, in an embodiment, includes the resource domain identifier included in the first resource's URL. The related resource identifier can then be provided to a related resource service (RRS) hosted by a related resource service node (RRSN) that represents a service domain that at least partially includes the resource domain identified by the resource domain identifier included in the first resource's locator, e.g., URL.

In an embodiment, the RRS is configured to maintain an association between the second resource and the resource domain identified by the resource locator of the first resource. In response to receiving the related resource accessor, the RRS is configured, in an embodiment, to resolve the related resource accessor to provide access to the second resource. For example, the RRS can be configured, in an embodiment, to resolve the accessor and to provide a related resource accessor identifying a node for accessing the second resource related to the first resource. Alternatively or additionally, the RSS can provide the second resource or otherwise provide access to the second resource. In either or both cases, resources related to a locatable resource, i.e., the first resource, can be accessed based on the related resource accessor which itself is based on the first resource's resource locator.

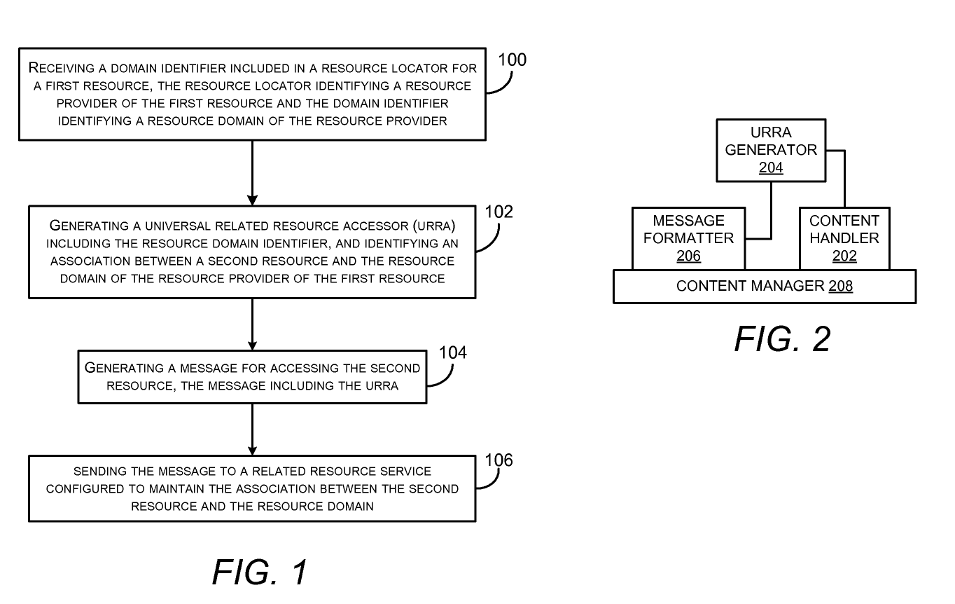

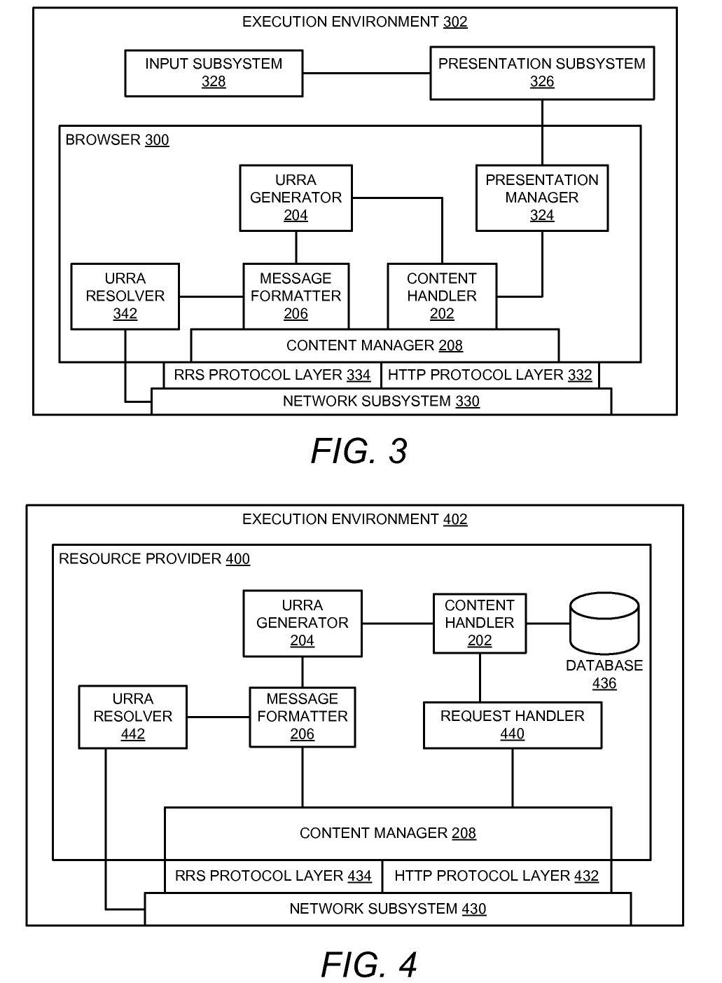

FIG. 1 is a flow diagram illustrating a method for providing access to resources related to a locatable resource according to an exemplary embodiment. FIGS. 2, 3, and 4 are block diagrams illustrating systems for providing access to resources related to a locatable resource according to embodiments of the subject matter described herein. In particular, FIG. 2 illustrates an arrangement of components configured for providing access to resources related to a locatable resource, while FIG. 3 and FIG. 4 illustrate the components of FIG. 2 and/or their analogs adapted for operation in execution environments provided by nodes for providing access to resources related to a locatable resource. The method illustrated in FIG. 1 can be carried out by, for example, at least some of the components in each of the exemplary arrangements of components illustrated in FIGS. 2, 3, and 4.

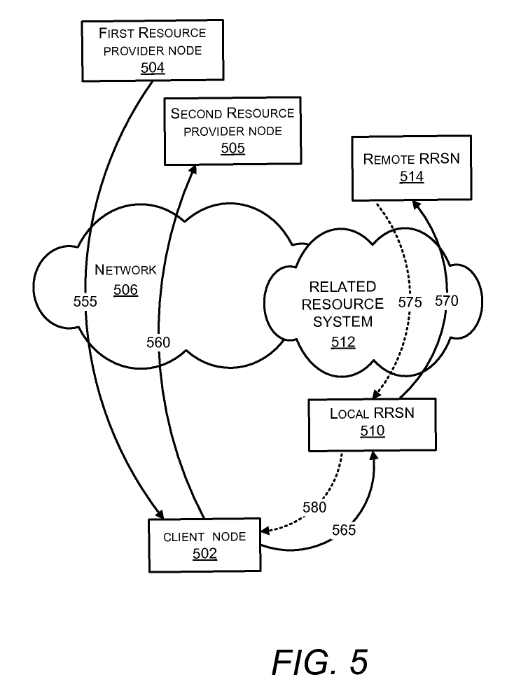

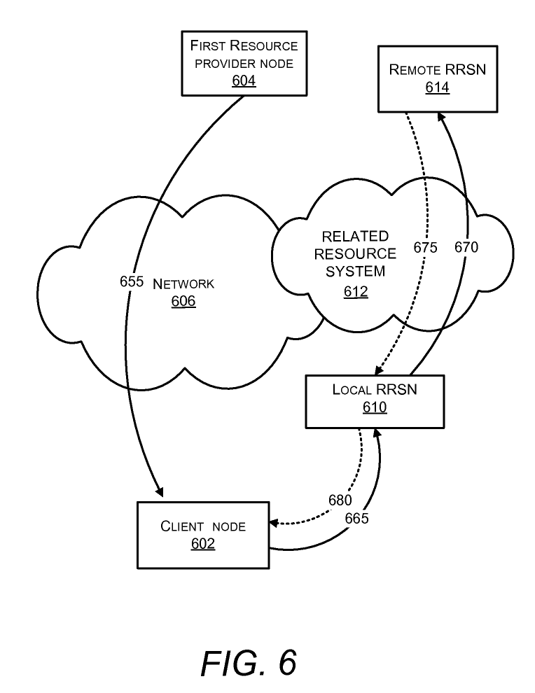

FIG. 2 illustrates components that are configured to operate within an execution environment hosted by a node and/or multiple nodes, as in a distributed execution environment. For example, in FIG. 5 and FIG. 6, which each illustrate a plurality of nodes communicatively coupled to one another via a network 506, 606 such as the Internet, client nodes 502, 602 and resource provider nodes 504, 505, 604 can be configured to provide respective execution environments configured to support the operation of the components illustrated in FIG. 2 and/or their analogs. Exemplary nodes can include desktop computers, servers, networking nodes, notebook computers, PDAs, mobile phones, digital image capture devices, routers, switches, and the like.

An exemplary execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require additional hardware and/or software subsystems according to their particular operational requirements. For example, a network subsystem can be included in the execution environment for enabling communication between nodes over the network 506, 606. An operating system, a persistent data storage subsystem, a memory management subsystem, and/or a process scheduler are other examples of components that can be required for various adaptations of the components illustrated in FIG. 2 and their functional analogs for performing the method in FIG. 1.

Illustrated in FIG. 3 is a browser 300 including the components illustrated in FIG. 2 adapted for operating in an execution environment 302. The execution environment 302, or an analog, can be provided by a node such as the client node 502, 602. Alternatively or additionally, as illustrated in FIG. 4, the components illustrated in FIG. 2 can be adapted for operation in a resource provider service 400 in an execution environment 402 provided by a resource provider node 504, 505, 604.

With reference to FIG. 1 in block 100, a resource domain identifier included in a resource locator for a first resource is received. In an embodiment, the resource locator identifies a resource provider of the first resource and the resource domain identifier identifies a resource domain of the resource provider. In an embodiment, a system for providing access to resources related to a locatable resource includes means for receiving a resource domain identifier included in a resource locator for a first resource. For example, FIG. 2 illustrates a content handler component 202 configured to receive a resource domain identifier included in a resource locator for a first resource, the resource locator identifying a resource provider of the first resource and the resource domain identifier identifying a resource domain of the resource provider.

According to an exemplary embodiment, the content handler component 202 can receive a resource locator included in configuration information of a browser 300 or resource provider 400, in the content of a resource, such as a link in a web page, in a resource identified by the resource locator, and/or in a message received along with at least a portion of the resource. The resource locator can be a URL of the first resource that identifies the first resource and its location. In another embodiment, the content handler component 202 can receive a URN identifying the first resource and can determine the resource locator of the first resource based on the URN. For example, the URN can be formatted to specify a resolver URL for accessing a resolver entity configured to resolve the URN. In an embodiment, the syntax of such a URN can be based on a “res-hint” Hypertext Transfer Protocol (HTTP) header defined in “WIRE—W3 Identifier Resolutions Extensions” by Girod, et al., proposed for HTTP in IETF draft-griod-w3-id-res-ext-00.txt. The hint, as specified in a res-hint header, can include the location and a protocol of a resolver (see, “URN Resolution Using WIRE” by Girod, et al., in IETF draft-girod-URN-res-using-wire-00.text) configured to determine a URL based on the URN.

In an exemplary embodiment, the content handler component 202 can be configured to receive the resource locator in a response to a request, in a notification associated with a subscription, in an unsolicited asynchronous message, and/or via input from a user or another component. In addition to identifying the resource, the resource locator can identify a resource provider, which can be hosted by a remote node or by a node on which the content handler component 202 is operating. In the later case, the resource locator can be used to access a local resource, for example via a URI with a “file” schema, and/or a database record via a URN scheme such as an ISBN URN or a Universal Product Code (UPC) URN scheme.

According to an embodiment, the components illustrated in FIG. 2, including the content handler component 202, can be adapted to operate in a browser 300 in an execution environment 302 provided by a node, such as the client node, e.g., 502, 602. Alternatively or additionally, the content handler component 202 can also be adapted to operate in a resource provider service 400 in an execution environment 402 provided by a node, such as a resource provider node 504, 505, 604. The content handler component 202 can be configured to process a particular type, e.g., MIME type, of content. Accordingly, while a single content handler component 202 is illustrated in FIG. 3 and FIG. 4, the browser 300 and the resource provider service 400 can support and include more than one content handler component 202 to process different data types. For example, a video stream content handler component 202 can be provided and configured to process a particular type or types of video data corresponding to a video stream, while an image content handler component 202 can also be provided and configured to process image data formats identifiable by MIME type. Additionally or alternatively, a content handler component 202 can be configured to process more than one type of markup language based data.

In the browser 300 and in the resource provider service 400, the resource domain identifier included in the resource locator can be received as incoming data. In an embodiment, the resource locator can be received in a message transmitted over the network 506, 606 and received by a client node 502 and/or a resource provider node 504. For example, in FIG. 5, a message 555 from a first resource provider node 504 is received by the client node 502, and a message 560 from the client node 502 is received by the first resource provider node 504. The message 555, 560 can be a response to a request, a notification associated with a subscription, and/or an unsolicited asynchronous message.

The incoming message can be received by the content handler component 202 via a network subsystem 330, 430. In an embodiment, the message is received via a protocol layer of the network subsystem 330, 430, or via an application protocol layer, or other higher protocol layer, as illustrated by an exemplary HTTP protocol layer 332, 432 among many possible standard and proprietary protocol layers. For example, the message can be received via an application protocol layer supporting a protocol specifically for communicating with and/or within a related resource system 512, 612. A RRS protocol layer 334, 434 can be provided and configured to support communications with a RRSN 510, 610. These higher protocol layers can encode, package, and/or reformat data for sending and receiving messages over a network layer, such as Internet Protocol (IP), and/or a transport layer, such as Transmission Control Protocol (TCP) and/or User Datagram Protocol (UDP).

In the browser 300, the content handler component 202 can receive the message via the network subsystem 330 and the content manager component 208 in an embodiment. The content manager component 208 can access at least a portion of the resource included in a received message, or in a message to be sent, and can parse the message into elements of the type(s) supported by the content handler component 202.

In the resource provider service 400, the content handler component 202 can receive the message via a content manager component 208 and a request handler 440. In an embodiment, the content manager component 208 is configured to access at least a portion of the resource included in the received message, or in a message to be sent, and separate the message into message portions, such as a message header and content portions, when content is present. The content manager component 208 can detect a message type, e.g. HTTP GET, HTTP POST, a publish-subscribe publish command, or a subscribe command, and provide the message content to a request handler 440. The request handler 440 can be configured to provide message content to one or more content handlers 202 according to the type of the content. The resource domain identifier in the resource locator can be included in the payload portion of a message, in a header, and/or in a trailer portion of a message. When the resource domain identifier is included in a message header and/or trailer, the request handler 440 and/or content manager component 208 can be configured to receive the resource domain identifier.

In another embodiment, the resource domain identifier included in the resource locator can be received and processed as outgoing data. When the data is outgoing, it can be sent as a message 555, 655 transmitted over the network 506, 606 by the first resource provider node 504, 604, or as a message 560 transmitted over the network 506 by a client node 502. In an embodiment, the message can include and/or reference a resource domain identifier included in a resource locator such as a URL, and can be transmitted via the sending node's network subsystem 330, 430.

In an embodiment, the network subsystem 330, 430 receives a message or portions of a message generated by the content handler component 202. The message can be provided by the content handler component 202 to a message formatter component 206 configured to build a message compatible with a protocol for transmitting the message. The message formatter 206 can be configured to interoperate directly with the protocol layer of the network subsystem 330, 430 or with an application protocol layer, as described above and illustrated by the exemplary HTTP protocol layer 332, 432 and the RRS protocol layer 334, 434.

A resource domain identifier included in a resource locator received by a content handler component 202 for including, and/or referencing, in an outgoing message can be received by the content handler component 202 from any of a variety of sources. For example, in the browser 300, the content handler component 202 can receive the domain identifier in the resource locator via a presentation manager 324 of the browser 300. The presentation manager 324 can be configured to interoperate with a presentation subsystem 326 in the execution environment 302 to present a graphical user interface (GUI) for the browser 300. Input, such as user input, can be received from an input device (not shown) by an input subsystem 328 of the execution environment 302. The input can be received in correspondence with a widget presented as part of the browser GUI by the presentation subsystem 326 interoperating with a display device (not shown) as directed by the presentation manager 324 directed by one or more content handler components 202.

The received input can correspond to a URL entered into a location bar widget of the browser GUI or a link presented in a web page in a page widget or tab widget of the browser GUI. An indication of the input can be provided to the presentation subsystem 326, which is configured to determine an application or other component to receive the input based on the correspondence between the input and the state of the presentation. The presentation subsystem 326 can determine that the input information is to be provided to the presentation manager 324 of the browser 300. The presentation manager 324 can be configured to determine one or more components configured to process the input such as the content handler component 202 controlling the presentation of a portion of the browser GUI corresponding to the input.

In another embodiment, the resource domain identifier included in the resource locator can be received from a data store. For example, the browser 300 can access a bookmark including a resource locator including a domain identifier from a locally accessible data store (not shown). Similarly, the resource provider service 400 can store data that can include and/or reference a resource locator including a domain identifier in a locally accessible data store 436. Such data can include media content, web pages, page templates, and/or scripts.

Accordingly, a resource domain identifier included in a resource locator can be received in processing an incoming message, in building and sending an outgoing message, and/or can be received from a non-network source, such as a user and/or another component operating in the same execution environment of the component receiving the domain identifier. Content handler components 202 have been described as exemplary components that can be configured to receive a domain identifier, but any of a number of other components can be configured to receive a domain identifier included in a resource locator including components illustrated in FIGS. 2, 3, and 4, and components not illustrated or described in this document.

Referring again to FIG. 1 in block 102, a Uniform Related Resource Accessor (URRA) for accessing a second resource related to the first resource is generated. In an embodiment, the URRA includes the resource domain identifier, and identifies an association between the second resource and the resource domain of the resource provider of the first resource. A system for providing access to resources related to a locatable resource includes means for generating a URRA for accessing a second resource related to the first resource. For example, FIG. 2 illustrates a URRA generator component 204 configured to generate a URRA for accessing a second resource related to the first resource, the URRA including the resource domain identifier, and identifying an association between the second resource and the resource domain of the resource provider of the first resource.

According to an embodiment, the URRA generator component 204 can be invoked by the content handler component 202 when the resource domain identifier in the resource locator is received. In an embodiment, the browser 300 and/or the resource provider 400 can be instructed, via configuration information and/or received input, to access a second resource related to the first resource identified by the resource locator. In an embodiment, the second resource can be metadata for the first resource, can be a service or application that processes the first resource, and/or can be related to the first resource in any other way that is stored or otherwise accessible. As used in this description, accessing the second resource includes, but is not limited to, retrieving the second resource and/or an accessor, such as URL, for the second resource, storing and/or reading the second resource, and updating the second resource. Updating the second resource can include creating the second resource.

In an embodiment, the URRA is defined by a URRA scheme for processing related resource queries. Unlike existing URLs, the URRA scheme for processing related resource queries does include an identifier of a host for processing the query. Rather, a URRA of the scheme can be routed to a host based on a host, resource, path, and/or query portion of the URL; or resolved to a URL from a second URL scheme, different from the scheme of the resource locator of the first resource,, identifying a host for processing any of a host, resource, path, and/or query portion of the URRA. Alternatively, an existing scheme such as HTTP can be used but interpreted as a URRA.

In an embodiment, the URRA generated by the URRA generator component 204 can be used as a URN or a second type of URL based on the URL, of the first resource where the URN is a parameter for routing message to a RRS. In one embodiment, the URRA includes at least a portion of the URL of the first resource. For example, the URRA includes at least the resource domain identifier included in the first resource's URL. In another embodiment, the URRA includes the entire URL of the first resource. Accordingly, the URL of the first resource identifies the resource provider and/or the location of the first resource, but, when used as a URRA, can identify and/or locate an association between a second resource and the resource domain of the first resource and/or the first resource as indicated by the related resource association.

The URRA generator component 204 can generate the URRA, in an embodiment, based on a lookup performed locally, a formula, and/or based on a template. In an embodiment, the template can be used to generate the URRA based on the resource domain identifier of the first resource. For example, a related resource service scheme providing a schema for a URRA for identifying the association between a second resource and the resource domain can be defined in the following exemplary manner:

RRS://domain/[path][?query]

As shown, the URRA begins with an “RRS” scheme identifier followed by a “://” prior to a domain portion of the URRA. The domain portion of the URRA includes the resource domain identifier of the resource provider of the first resource. The domain portion can be followed by an optional path portion and/or an optional query portion. In an embodiment, the path portion of the URRA can be the path portion of the resource locator of the first resource. The query portion can be message specific and is not restricted to a “resource=resourceID” keyword pair. In an embodiment, an “action=actionID” pair can be included in the URRA for performing an operation on an association between a second resource and a first resource and/or an association between a second resource and a resource domain identified in the resource locator of the first resource.

To illustrate further, consider the following valid URRAs generated based on the RRS schema described above, where an exemplary URL of a first resource is “http :myhost.com/books/fiction?title=“Gone with the Wind”:

RRS://myhost.com
RRS://myhost.com/books
RRS://myhost.com/books/fiction
RRS://myhost.com/ books/fiction?title=”Gone with the Wind”
RRS://myhost.com/ books/fiction?resource=”Atlanta”
RRS://myhost.com/ books/fiction?title=”Gone with the
Wind&resource=”Atlanta”

As shown, each URRA above is valid and identifies an association between a second resource and a resource domain of the resource provider. Nevertheless, some of the URRAs can identify an association identifying a second resources not related to the first resource identified by the resource locator in addition to identifying an association identifying a related second resource.

Referring again to FIG. 1 in block 104, once the URRA is generated, a message including the URRA is generated for accessing the second resource. A system for providing access to resources related to a locatable resource includes means for generating a message including the URRA for accessing the second resource. For example, FIG. 2 illustrates a message formatter component 206 configured to generate a message including the URRA for accessing the second resource.

According to an exemplary embodiment, the message can be generated in response to receiving the resource domain identifier included in the resource locator and/or in response to another associated event, such as a user input event, a timer event, a network event, and/or any event detectable within the execution environment 302, 402. For example, the content handler component 202 and/or any other component receiving the resource domain identifier can invoke the message formatter component 206, which can be adapted for operation in the browser 300 and in the resource provider service 400.

The message formatter component 208 is configured, in an embodiment, to receive the URRA from the URRA generator component 204 and to generate the message according to a protocol specification supported by the protocol layer operatively coupled to the message formatter 208 such as the HTTP protocol layer 332, 432 or any other suitable protocol. In other embodiments, the content handler component 208, the content manager component 208, an application protocol layer, and/or a component of the network subsystem 330, 430 can interoperate with the URRA generator component 204 to include the URRA in the message prior to and/or after invocation of the message formatter component 206.

Referring again to FIG. 1 in block 106, once generated, the message is sent to a RRS maintaining the association between the second resource and the resource domain. In an embodiment, the RRS is configured to receive and process the URRA to provide access to the second resource. A system for providing access to resources related to a locatable resource includes means for sending the message to an RRS maintaining the association between the second resource and the resource domain. For example, FIG. 2 illustrates a content manager component 208 configured to send the message to an RRS maintaining the association between the second resource and the resource domain, wherein the RRS is configured to receive and process the URRA to provide access to the second resource.

According to an exemplary embodiment, the RRS is hosted by a Related Resource Service Node (“RRSN”) representing a service domain at least partially including the identified resource domain of the first resource. The RRS can be a centralized service hosted by an RRSN or a cluster of RRSNs providing a related resource system in an embodiment. Alternatively, the related resource system can be include RRSNs hosting relates resource services (RRSs) included in a distributed collection of nodes representing various service domains in the related resource system in another embodiment.

The message can be received by a routing node configured to route the message to the RRS. The routing node can be associated with one or more network identifiers of one or more network interfaces, none of which include the resource domain identifier of the first resource. In an embodiment, the message formatter component 206 can be configured to determine and/or to provide a network address of the routing node. In one embodiment, the network address of the routing node can be provided in configuration data of a node in which the message formatter component 206 is operating.

Alternatively or additionally, the network address can be received from user input, received in a resource, received when the URRA is generated, received from a remote node, in response to a request, and/or generated based on at least one of a configured template, an identifier of a schema of the second resource, an identifier of a resource, and an accessor of the second resource. The network address of the routing node can be received, in an embodiment, over the network from a management server, such as a Dynamic Host Configuration Protocol (DHCP) server. Alternatively, the network address provided or determined can be that of the RRSN hosting the RRS, i.e., the routing node is the hosting RRSN. In this embodiment, the message formatter component 206 can be configured to send the message to the RRSN hosting the RRS, where the message can include the network address as a destination address for the message.

According to another embodiment, the browser 300 and the resource provider service 400 can include a URRA resolver 342, 442 configured to generate a query for an identifier, e.g., a URL, of the RRSN hosting the RRS. The message formatter component 206 and/or the URRA generator component 204 can be configured to invoke, and to provide the URRA to, the URRA resolver 342, 442. In an embodiment, a query including the URRA can be sent to a resolving service (not shown), via the network subsystem 330, 430, using any protocol defined for interoperating with the resolving service. In an embodiment, the resolving service can be analogous to a Domain Name System (DNS) service and/or a Lightweight Directory Access Protocol (LDAP) service, where a URL for the RSSN hosting the RRS can be determined and provided based on the URRA.

In an embodiment, the RRS scheme for a URRA, described above, can be modified to include a “resolver” scheme modifier comprising a “%variable1%” portion that can be provided by the URRA resolver 342, 442 identifying a resolving service configured to return a URL for the URRA, or to identify another node that may be able to resolve the URRA to a URL. Exemplary scheme modifiers are described in pending patent applications entitled “Methods And Systems For Accessing A Resource Based on URN Scheme Modifiers,” patent application Ser. No. 11/957,809 (Attorney Docket No. 1482/US), filed Dec. 17, 2007, and “Method and System For Managing Metadata Associated With A Resource,” patent application Ser. No. 12/273,003 (Attorney Docket No. 1542/US), filed Nov. 18, 2008 both assigned to the assignee of the present patent application and herein incorporated by reference in their entirety. An example below illustrates the modified schema for URRAs based on the RRS scheme described above.

RRS:resolver=“%variable1%”//domain/resource ID?command=add

As described earlier, the URRA begins with the “RRS” scheme identifier and a domain portion of the URRA. In addition, the URRA includes a “resolver” scheme modifier that comprises a “%variable1%” portion that can be provided by the URRA resolver 342, 442 identifying a resolver node hosting the resolving service configured to return a URL corresponding to the URRA, or to identify another node that may be able to resolve the URRA to a URL. In an embodiment, the resolver node URL can be provided to the URRA resolver 342, 442 via a DHCP server for providing a value for the “%variable1%” portion of the resolver scheme modifier.

In an embodiment, one or more operation commands can be processed with respect to the second resource, as illustrated by the “command=add” portion supported by the exemplary scheme. For example, in this embodiment, the second resource can be a service configured to execute the command included in the URRA. The service, for instance, can be configured to receive a representation of the first resource as input and/or to provide a representation of at least a portion of the first resource as output.

For any detected instance of a related resource to the first resource, one or more URRAs can be generated based on a domain identifier associated with each respective related resource. Each related resource can be associated with a respective service domain of an RRS for maintaining an association between the related resource and a first resource having a URL or other resource locator. Thus, given a service domain or a related resource, the first locatable resource can be identified.

According to an embodiment, the message for accessing the second resource and including the URRA generated by the message formatter component 206 is provided to the content manager component 208, which determines a protocol component compatible with the message. The message can be transmitted using any protocol supported by the RRS operating in an execution environment provided by an RRSN, such as a local RRSN 510, 610, included in a network of RRSNs included in the related resource system 512, 612. For example, the message can be transmitted using an RRS protocol supported by the RRS protocol layer 334, 434. The compatible protocol layer, e.g., 334, 434, sends the message as a whole or in parts via the network subsystem 330, 430 over the network to the RRSN 510, 610.

For example, referring to FIG. 5 and FIG. 6, the content manager component 208 operating in the client node 502, 602 is configured to send the message for accessing the second resource and including the URRA 565, 665 to an RRSN, e.g., the local RRSN 510, 610, in the RRS system 512, 612. Similarly, the content manager component 208 operating in the resource provider node 504, 505, 604 can be configured to send the message to an RRSN 510, 610. As stated above, the network address of the RRSN 510, 610 can be determined in several ways. For example, it can be provided in the configuration data of the client node 502, 602, provided by a user, received from a remote node, and/or generated.

According to an embodiment, each RRSN 510, 514, 610, 614 represents a service domain and can be configured to maintain related resource associations between related resources and resource domains of locatable resources that are at least partially included in the service domain. In an embodiment, an RRSN, e.g., 514, can be configured to maintain a resource locator, such as a URL, for a second (related) resource for accessing the second resource. Alternatively or additionally, the RRSN, e.g., 614, can be configured to maintain, e.g., store, an instance of a second resource. For example, the RRSN 614 can be a metadata repository service node described in the pending patent application entitled “Method and System For Managing Metadata Associated With A Resource,” (Attorney Docket No. 1542US) described above. As such, the RRSN 614 can be configured to store a second resource, e.g., metadata, related to a first resource in the metadata domain. The metadata domain can be the domain of the resource provider providing access to a metadata schema specification as an exemplary first resource.

In an embodiment, when the message is received by the RSSN, e.g., the local RRSN 510, 610, it can determine whether the RSSN 510, 610 represents a service domain that at least partially includes the resource domain identified by the URRA in the message. When the resource domain is not at least partially included in the service domain, the receiving RRSN 510, 610 can route the message 570, 670, based on the resource domain identifier, to another RSSN 514, 614 in the RRS System 512, 612 that represents a service domain that at least partially includes the resource domain.

When the resource domain is at least partially included in the service domain represented by the RRSN, e.g., the local RRSN 510, 610, a response message 580, 680 can be sent to the client node 502, 602 in an embodiment. Alternatively, when the RRSN representing a matching service domain is a remote RRSN 514, 614, the remote RRSN 514 can send a response message 575, 675 to the local RRSN 510. The local RRSN 510, 610 can send the response message 580, 680 to the client node 502, 602 in response to receiving the message 575, 675. Depending on the circumstances, the response message 580, 680 can be required or optional. For example, when the message 565, 665 requests a representation of a related resource for presentation, a response message 580, 680 is required. Alternatively, when the message 565, 665 includes a command and/or other indication for accessing and operating on the related resource, a response message is not required, but can be sent when supported by the protocol in use. If, for example, the protocol used supports one-way communication, such as an asynchronous protocol, a response message can be optional.

According to an embodiment, the response message, e.g., 575, 580, can include an accessor, such as a URL, for accessing the second related resource. For example, referring to FIG. 5, the accessor can identify a second resource provider node 505 as a resource provider for the second resource. The content handler component 202 in the client node 502 can be configured to receive the response message 580 including the accessor for accessing the second related resource. The accessor can be passed to the message formatter component 206 which uses the content manager component 208 to send a message 560 to access the second resource addressed to the second resource provider 505 based on the accessor.

In another embodiment when the RRSN 610, 614 maintains an instance of a second resource, the response message, e.g., 675, 680, can include at least a portion of the second resource. Alternatively or additionally, the response message 675, 680 can include an indication of the result of an access of the second resource and/or can complete an access by the client node 602 processing at least a portion of the second resource returned in the response message 675, 680. In an embodiment the content handler component 202 in the client node 602 can also be configured to receive the response message 675, 680 including at least a portion of the second resource.

In an embodiment, an RRSN, e.g., 510, 610, can return second resource information included in all related resource associations that match the identified resource domain. The client node 502, 602 receiving this information can be configured to identify a second resource related to the first resource based on matching at least a portion of an identifier of the first resource included in a second resource information instance. Alternatively, a related resource association between a resource domain of the first locatable resource and a second resource can identify the resource domain by including an identifier of the first resource identifying the resource domain. Such a related resource association can associate the first resource with a second resource. An RRSN 510, 610, 514, 614 that maintains related resource associations including an identifier of the first resource can send a response 575, 675, 580, 680 identifying one or more second resources related to the first resource.

While exemplary resource identifiers above, such as URLs, have been based on names from a naming domain, the identifier of a resource can also be based on a network address or any suitable naming system that can be segmented into domains. For example, a resource locator can be a geospatial identifier, such as a network address and/or a symbolic name.

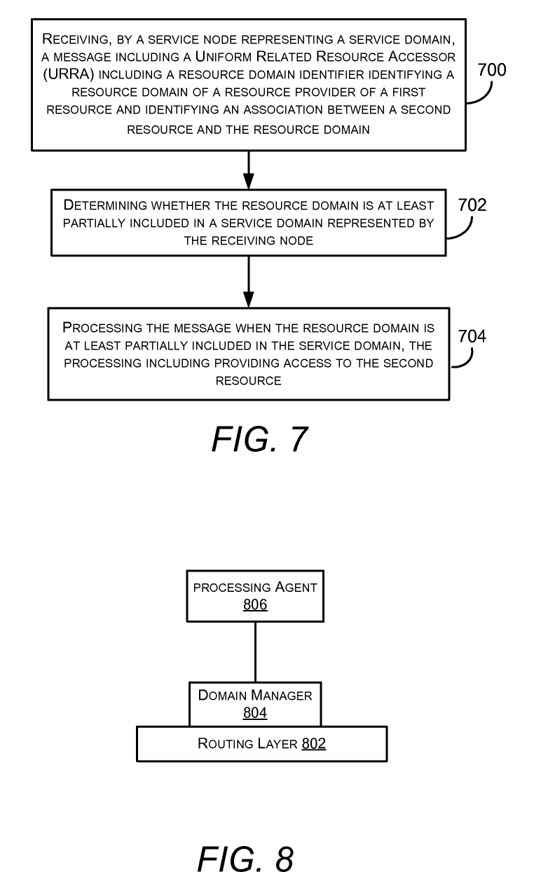

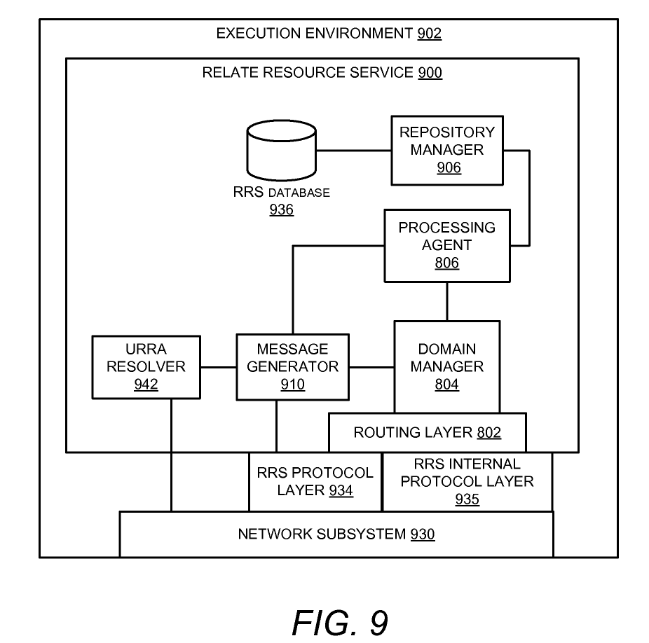

FIG. 7 is a flow diagram illustrating a method for providing access to resources related to a locatable resource according to another aspect of the subject matter described herein. In particular, the method is from the perspective of the RRS or an analog. FIGS. 8 and 9 are block diagrams illustrating systems for providing access to resources related to a locatable resource according to embodiments of the subject matter described herein. In particular, FIG. 8 illustrates an arrangement of components configured for providing access to resources related to a locatable resource, while FIG. 9 illustrates the components of FIG. 8 and/or their analogs adapted for operation in an execution environment provided by one or more nodes for providing access to resources related to a locatable resource. The method illustrated in FIG. 7 can be carried out by, for example, at least some of the components in each of the exemplary arrangements of components illustrated in FIGS. 8 and 9. For example, illustrated in FIG. 9 is an RRS 900 including the components illustrated in FIG. 8 adapted for operating in an execution environment 902 provided by a node such as the RRSN 510, 514, 610, 614.

Referring to FIG. 7 in block 700, a message is received by an RSSN representing a service domain. In an embodiment, the message includes a URRA including a resource domain identifier, which identifies a resource domain of a resource provider of a first resource. The URRA identifies an association between a second resource and the resource domain. According to an exemplary embodiment, a system for providing access to resources related to a locatable resource includes means for receiving, by an RSSN representing a service domain, a message including a URRA. For example, FIG. 8 illustrates a routing layer component 802 in an RSSN configured to receive a message including a URRA including a resource domain identifier, which identifies a resource domain of a resource provider of a first resource, and identifying an association between a second resource and the resource domain.

In an embodiment, the RRSN can be accessed based on an identifier in a domain space also including the resource domain and/or a related resource (second resource) domain. The identifier for accessing of the RRSN can be in a domain that is not included in either or both of the related resource domain and the resource domain.

According to an exemplary embodiment, the message can be received by a routing layer component 802 included in an RRS 900 operating in an execution environment 902 provided by an RRSN, e.g., 510, 610, representing a service domain. In an embodiment, the message, e.g., 565, 665, can be received from the client node 502, 602, or from the resource provider node 504, 604. The message 565, 665 can be transmitted from the sending node via the network 506, 606 and received by the routing layer component 802 via a network subsystem 930 and optionally a higher layer protocol, such as an RRS protocol layer 934 or an RRS Internal protocol layer 935 provided for communication between RRSNs in the related resource system 512, 612. In an embodiment, the RRS protocol layer 934 and the RRS Internal protocol layer 935 can support a single protocol or different protocols.

In an embodiment, the received message 565, 665 is the same message generated and sent according to the method described in FIG. 1. Accordingly, an exemplary URRA included in the message 565, 665 is described in more detail above. The message 565, 665 can be a request for the second resource related to the first resource, where the second resource includes metadata for the first resource.

Referring again to FIG. 7 the method continues in block 702, by determining whether the resource domain identified by the resource domain identifier in the URRA is at least partially included in the service domain represented by the RRSN. According to an exemplary embodiment, a system for providing access to resources related to a locatable resource includes means for determining whether the resource domain identified by the resource domain identifier in the URRA is at least partially included in the service domain represented by the RRSN. For example, FIG. 8 illustrates a domain manager component 804 configured to determine whether the resource domain identified by the resource domain identifier in the URRA is at least partially included in the service domain represented by the RRSN.

According to an embodiment, the routing layer component 802, in response to receiving the message including the URRA 565, 665, can provide at least a portion of the URRA to the domain manager component 804 based on an attribute of the message, such as a message type and/or a command code included in the message 565, 665. The domain manager component 804 can be adapted to operate in the RRS 900 operating in the execution environment 902 provided by an RRSN, e.g., 510, 610.

The domain manager component 804 can be configured, in an embodiment, to determine whether the resource domain is at least partially included in the service domain represented by the receiving RRSN 510, 610 by performing a matching algorithm and/or performing a lookup in a table or other storage location for locating a matching entry. For example, the domain manager component 804 can be configured to compare the identifiers of the resource domain and the service domain, and to determine whether the two identifiers are included in the same domain space, such as a DNS name space or an IP address name space. In an embodiment, the service domain represented by the RRSN 510, 610 can identify a specific domain or can be expressed as a matching expression, such as a regular expression, allowing any number of resource domains to match the service domain expression.

In an embodiment, matching can include converting one of the domain identifiers from a first domain space into a domain identifier in a second domain space corresponding to the domain space of the other domain identifier, and comparing the domain identifiers. For example, the resource domain identifier can be a name in a naming domain space, or a subnet identifier in a network address domain space, and determining whether the resource domain is at least partially included in the service domain can include mapping the resource domain identifier to a domain space corresponding to the domain space of the service domain identifier, and comparing the mapped resource domain identifier to the service domain identifier.

For instance, if the resource domain identifier is included in an IP address name space and identifies a subnet, and the service domain is identified as a domain in a DNS name space, the subnet address of the resource domain identifier can be mapped to one or more identifiers in the DNS name space identifying DNS domains. Each of the mapped DNS names can be matched against the service domain identifier to determine whether there is at least an overlap between the nodes in the subnet identified as the resource domain and the naming domain identified as the service domain. An identifier from a geospatial identifier domain space that identifies geospatial regions can identify one or both of the domains. Mapping to and/or from a geospatial identifier domain to another type of domain can be performed when required.

Referring again to FIG. 7, in block 704, when the resource domain is determined to be at least partially included in the service domain, the message is processed, where such processing includes providing access to the second resource. According to an exemplary embodiment, a system for providing access to resources related to a locatable resource includes means for processing the message when the resource domain is determined to be at least partially included in the service domain. For example, FIG. 8 illustrates a processing agent component 806 configured to process the message when the resource domain is determined to be at least partially included in the service domain, the processing including providing access to the second resource.

When the resource domain is determined to be at least partially included in the service domain, the domain manager component 804 can provide an indication to the processing agent component 806 to this effect. According to an exemplary embodiment, the processing agent component 806 can be configured to process the message 565, 665 by, for example, locating a storage area for storing a new association between the second resource and the resource domain, reading the second resource, updating at least a portion of the second resource, and/or deleting at least a portion of the second resource. In addition, the processing agent component 806 can be configured to receive at least a portion of the second resource and/or a second resource locator for accessing the second resource.

For example, in an embodiment, the processing agent component 806 can invoke a repository manager 906 operatively coupled to a related resource association (RRA) database 936, and configured to locate a related resource association between a second resource and the identified resource domain, and optionally the first resource if identified. For example, the related resource association can identify the second resource and a resource from a provider having a domain identifier in the resource domain, such as the first resource.

According to an embodiment, the RRA database 936 can store second resources related to the resource domain and potentially the first resource, and/or accessors of such second resources. The RRA database 936 can include a table of records where each record can include an accessor of a second resource and an identifier of a resource domain included at least partially in the service domain represented. Additionally, each record can include a resource locator including an identifier of a domain included at least partially in the service domain represented.

The processing agent component 806 can provide the resource domain identifier, and optionally the resource locator for the first resource, to the repository manager 906. In response, the repository manager 906 can query the RRA database 936 for all second resources (and/or accessors of second resources), and/or all second resources associated with the resource domain at least partially included in the identified resource domain in the message. In addition, the repository manager 906 can query the database 936 for all second resources and/or accessors of second resources associated with an identifier of the first resource having the resource locator. When a second resource and/or its accessor, is located, at least a portion of the second resource and/or its accessor can be returned by the repository manager 906 to the processing agent component 806 for further processing.

For example, in an embodiment, the processing agent component 806 can be configured to process the second resource or a portion thereof directly, and/or by calling another component to process the second resource. In another embodiment, the processing agent component 806 can be configured to request a remote node to process the second resource, and/or send a response allowing a receiver of the message to process the second resource.

In an embodiment, the processing can be any operation including, but not limited to, updating, reading, transmitting, and/or deleting at least a portion of the second resource. For example, the processing agent component 806 can be figured to process the second resource by invoking the message generator component 910. The message generator component 910 is configured to generate a response message, e.g., 580, 680, including the second resource locator and/or at least a portion of the second resource, and to send the response message 580, 680 to a receiving node, such as a client node 502, 602 from which the message including the URRA was sent.

When the repository manager 906 fails to locate a second related resource, an indication indicating no match was located can be provided to the domain manager component 804. The domain manager component 804 can provide the negative indication to another component, such as the message generator 910, configured to process messages indicating no related resource is included in the RRA database 936. The message generator 910 can generate a response message 580, 680 consistent with not locating a second related resource.

When the domain manager component 804 determines that the resource domain is not at least partially included in the service domain, the domain manager component 804 can discard the received message 565, 665 or can return a response 580, 680 indicating that the RRSN 510, 610 does not represent a service domain at least partially including the resource domain to the sending node, e.g., the client node 502, 602. Alternatively, the domain manager component 804 can provide for routing the received message to another RRS hosted by another RRSN, e.g., a remote RRSN 514, 516, representing another service domain. In an embodiment, the domain manager component 804 can invoke the message generator 910, which is configured to generate a second message 570, 670 including at least a portion of the URRA, and to send the second message 570, 670 for routing to a second RRSN 514, 516 representing a second service domain.

According to an exemplary embodiment, when the second message is to be sent for routing to the second RRSN 514, 516, the message generator 910 is configured to determine a network address of a node configured to route the second message to the second RRSN 514, 516. In an embodiment, the message generator 910 can be configured with the network address of the second RRSN 514, 516. In other embodiments, the network address of the second RRSN 514, 516 can be received with the message, received from a resolver service (not shown) in response to a request, and/or received with the sending application. In another alternative, the network address of the second RRSN 514, 516 can be generated based on an accessor of the second resource, an identifier of the first resource, and/or an identifier the resource domain.

In an embodiment, the message generator 910 can invoke a URRA resolver 942, which can be configured to generate or otherwise determine the accessor for accessing the second RRSN 514, 516, as described above. For example, in an embodiment, the URRA resolver 942 can send a query to a resolver service (not shown) to determine an accessor for the second RRSN 514, 516 hosting the second RRS and representing the second service domain. The query can include a service type identifying an RRS type and/or the resource domain identifier described above. Based on the query, the resolver service can identify the second RRSN 514, 516, and return an accessor of the second RRSN 514, 516 in a response message. The message generator 910 can use the accessor of the second RRSN 514, 516 to route the second message to the second RRSN 514, 516.

In an embodiment, the routing layer component 802 in the sending RRSN 510, 610 can be configured to receive a response 575, 675 from the second RRSN 514, 516. The message generator component 910 can be invoked to generate a second response message 580, 680 including or otherwise based on the response 575, 675 from the second RRSN 514, 516, and send the second response message 580, 680 to the client node 502, 602.

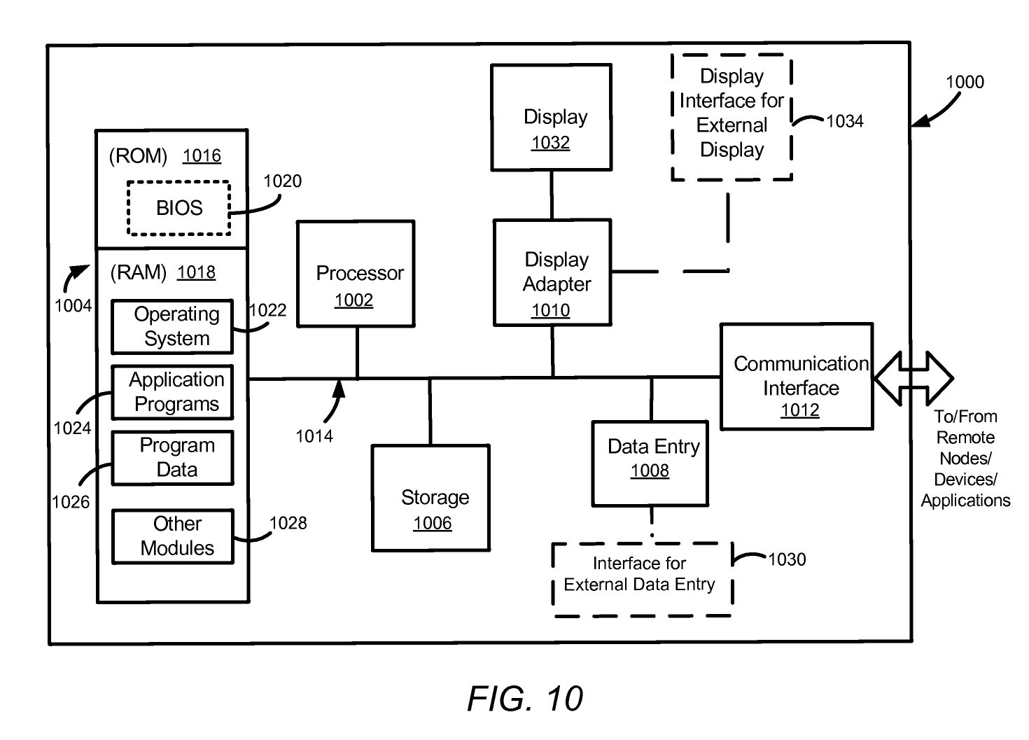

FIG. 10 illustrates an exemplary hardware device in which the subject matter disclosed herein may be implemented. Those of ordinary skill in the art will appreciate that the elements illustrated in FIG. 10 may vary depending on the system implementation. With reference to FIG. 10, an exemplary system includes a hardware device 1000, including a processing unit 1002, memory 1004, storage 1006, data entry 1008, display adapter 1010, communication interface 1012, and a bus 1014 that couples elements 1004-1012 to the processing unit 1002.

The bus 1014 may comprise any type of bus architecture. Examples include a memory bus, a peripheral bus, a local bus, etc. The processing unit 1002 is an instruction execution machine, apparatus, or device and may comprise a microprocessor, a digital signal processor, a graphics processing unit, an ASIC (application specific integrated circuit), a field programmable gate array (FPGA), etc. The processing unit 1002 may be configured to execute program instructions stored in memory 1004 and/or storage 1006 and/or received via data entry 1008.

The memory 1004 may include read only memory (ROM) 1016 and random access memory (RAM) 1018. Memory 1004 may be configured to store program instructions and data during operation of device 1000. In various embodiments, memory 1004 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or Rambus DRAM (RDRAM), for example. Memory 1004 may also include nonvolatile memory technologies such as nonvolatile “flash” RAM (NVRAM) or ROM. In some embodiments, it is contemplated that memory 1004 may include a combination of technologies such as the foregoing, as well as other technologies not specifically mentioned. When the subject matter is implemented in a computer system, a basic input/output system (BIOS) 1020, containing the basic routines that help to transfer information between elements within the computer system, such as during start-up, is stored in ROM 1016.

The storage 1006 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1000.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, random access memories, read only memories, and the like may also be used in the exemplary operating environment. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

A number of program modules may be stored on the storage 1006, ROM 1016 or RAM 1018, including an operating system 1022, one or more applications programs 1024, program data 1026, and other program modules 1028. A user may enter commands and information into the hardware device 1000 through data entry module 1008. Data entry 1008 may include mechanisms such as a keyboard, a touch screen, a pointing device, etc. Other external input devices (not shown) are connected to the hardware device 1000 via external data entry interface 1030. By way of example and not limitation, external input devices may include a microphone, joystick, game pad, satellite dish, scanner, or the like. In some embodiments, external input devices may include video or audio input devices such as a video camera, a still camera, etc. Data entry 1008 may be configured to receive input from one or more users of device 1000 and to deliver such input to processing unit 1002 and/or memory 1004 via bus 1014.

A display 132 is also connected to the bus 1014 via display adapter 1010. Display 1032 may be configured to display output of device 1000 to one or more users. In some embodiments, a given device such as a touch screen, for example, may function as both data entry 1008 and display 1032. External display devices may also be connected to the bus 1014 via external display interface 1034. Other peripheral output devices, not shown, such as speakers and printers, may be connected to the hardware device 1000.

The hardware device 1000 may operate in a networked environment using logical connections to one or more remote nodes (not shown) via communication interface 1012. The remote node may be another computer, a server, a router, a peer device or other common network node, and typically includes many or all of the elements described above relative to the hardware device 1000. The communication interface 1012 may interface with a wireless network and/or a wired network. Examples of wireless networks include, for example, a BlueTooth network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 1012 may include logic configured to support direct memory access (DMA) transfers between memory 1004 and other devices.

In a networked environment, program modules depicted relative to the hardware device 1000, or portions thereof, may be stored in a remote storage device, such as, for example, on a server. It will be appreciated that other means of establishing a communications link between the hardware device 1000 and other devices may be used.

It should be understood that the arrangement of hardware device 1000 illustrated in FIG. 10 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 1000. In addition, while at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 10. Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description above, the subject matter has been described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for providing access to resources related to a locatable resource, the method comprising:
receiving a resource domain identifier included in a resource locator for a first resource, the resource locator identifying a resource provider of the first resource and the resource domain identifier identifying a resource domain of the resource provider;
generating a Uniform Related Resource Accessor (URRA) for accessing a second resource related to the first resource, the URRA including the resource domain identifier, and identifying an association between the second resource and the resource domain of the resource provider of the first resource;
generating a message including the URRA for accessing the second resource; and
sending the message to a related resource service maintaining the association between the second resource and the resource domain,
wherein the related resource service is configured to receive and process the URRA to provide access to the second resource, and wherein at least one of the preceding actions is performed on at least one electronic hardware component.

2. The method of claim 1 wherein receiving the resource domain identifier included in the resource locator includes receiving a Uniform Resource Name (URN) identifying the first resource and determining the resource locator based on the URN.

3. The method of claim 1 wherein the resource locator is a Uniform Resource Locator (URL) and the URRA includes at least a portion of the URL.

4. The method of claim 3 wherein the URL for the first resource is a Uniform Resource Name (URN) identifying a related resource service.

5. The method of claim 1 wherein sending the message to the related resource service includes determining a network address of a node configured to route the message to the related resource service hosted by a node representing a service domain at least partially including the resource domain identifier, wherein the determined network address is at least one of provided in configuration data of a sending node, received from user input, received in a resource, received when the URRA is generated, received from a remote node in response to a request, and generated based on at least one of a configured template, an identifier of a schema of the second resource, an identifier of a resource, and an accessor of the second resource.

6. The method of claim 5 wherein the domain identified in the URRA is not included in any network identifier of any network interface of the node configured to route the message.

7. The method of claim 1 further comprising receiving, from the related resource service, a response including one of at least a portion the second resource and an accessor for accessing the second resource.

8. A method for providing access to resources related to a locatable resource, the method comprising:
receiving, by a related resource service node (RRSN) representing a service domain, a message including a Uniform Related Resource Accessor (URRA) including a resource domain identifier, which identifies a resource domain of a resource provider of a first resource, and identifying an association between a second resource and the resource domain;
determining whether the resource domain identified by the resource domain identifier in the URRA is at least partially included in the service domain represented by the RRSN; and
processing the message when the resource domain is determined to be at least partially included in the service domain, the processing including providing access to the second resource,
wherein at least one of the preceding actions is performed on at least one electronic hardware component.

9. The method of claim 8 wherein the resource domain identifier comprises one of a name in a naming domain space and a subnet identifier in a network address domain space, and wherein determining whether the resource domain is at least partially included in the service domain includes mapping the resource domain identifier to a domain space corresponding to the domain space of a service domain identifier and comparing the mapped resource domain identifier to the service domain identifier.

10. The method of claim 8 wherein processing the message includes at least one of locating a storage area for storing a new association between the second resource and the resource domain, reading the second resource, updating at least a portion of the second resource, and deleting at least a portion of the second resource.

11. The method of claim 8 wherein processing the message includes at least one of receiving at least a portion of the second resource, and receiving a second resource locator for accessing the second resource.

12. The method of claim 8 wherein processing the message includes generating a response message including at least one of a second resource accessor and at least a portion of the second resource, and sending the response message to a receiving node, wherein the receiving node is a node from which the message including the URRA was sent.

13. The method of claim 8 wherein when the resource domain is determined not to be at least partially included in the service domain, the method further includes generating a second message including at least a portion of the URRA, and sending the second message for routing to a second RRSN representing a second service domain.

14. The method of claim 13 wherein sending the second message for routing to the second RRSN includes determining an address of a node configured to route the second message to the second RRSN, wherein the determined address is at least one of provided in configuration data of the sending RRSN, received with the message, received from a resolver service in response to a request, and generated based on at least one of the accessor of the second resource, the identifier of the first resource, and the identifier of the resource domain.

15. A computer readable medium storing a computer program, executable by a machine, for providing access to resources related to a locatable resource, the computer program including executable instructions for:
receiving a resource domain identifier included in a resource locator for a first resource, the resource locator identifying a resource provider of the first resource and the resource domain identifier identifying a resource domain of the resource provider;
generating a Uniform Related Resource Accessor (URRA) for accessing a second resource related to the first resource, the URRA including the resource domain identifier, and identifying an association between the second resource and the resource domain of the resource provider of the first resource;
generating a message including the URRA for accessing the second resource; and
sending the message to a related resource service maintaining the association between the second resource and the resource domain.

16. A computer readable medium storing a computer program, executable by a machine, for providing access to resources related to a locatable resource, the computer program including executable instructions for:
receiving, by a related resource service node (RRSN) representing a service domain, a message including a Uniform Related Resource Accessor (URRA) including a resource domain identifier, which identifies a resource domain of a resource provider of a first resource, and identifying an association between a second resource and the resource domain;
determining whether the resource domain identified by the resource domain identifier in the URRA is at least partially included in the service domain represented by the RRSN; and
processing the message when the resource domain is determined to be at least partially included in the service domain, the processing including providing access to the second resource.

17. A system for providing access to resources related to a locatable resource, the system comprising:
means for receiving a resource domain identifier included in a resource locator for a first resource, the resource locator identifying a resource provider of the first resource and the resource domain identifier identifying a resource domain of the resource provider;
means for generating a Uniform Related Resource Accessor (URRA) for accessing a second resource related to the first resource, the URRA including the resource domain identifier, and identifying an association between the second resource and the resource domain of the resource provider of the first resource;
means for generating a message including the URRA for accessing the second resource; and
means for sending the message to a related resource service maintaining the association between the second resource and the resource domain,
wherein at least one of the means includes at least one electronic hardware component.

18. A system for providing access to resources related to a locatable resource, the system comprising:
means for receiving, by a related resource service node (RRSN) representing a service domain, a message including a Uniform Related Resource Accessor (URRA) including a resource domain identifier, which identifies a resource domain of a resource provider of a first resource, and identifying an association between a second resource and the resource domain;
means for determining whether the resource domain identified by the resource domain identifier in the URRA is at least partially included in the service domain represented by the RRSN; and
means for processing the message when the resource domain is determined to be at least partially included in the service domain, the processing including providing access to the second resource,
wherein at least one of the means includes at least one electronic hardware component.

19. A system for providing access to resources related to a locatable resource, the system comprising system components including:
a content handler component configured to receive a resource domain identifier included in a resource locator for a first resource, the resource locator identifying a resource provider of the first resource and the resource domain identifier identifying a resource domain of the resource provider;
a related resource accessor generator component configured to generate a Uniform Related Resource Accessor (URRA) for accessing a second resource related to the first resource, the URRA including the resource domain identifier, and identifying an association between the second resource and the resource domain of the resource provider of the first resource;
a message formatter component configured to generate a message including the URRA for accessing the second resource; and
a content manager component configured to send the message to a related resource service maintaining the association between the second resource and the resource domain,
wherein at least one of the system components includes at least one electronic hardware component.

20. The system of claim 19 wherein the content handler component is configured to receive a Uniform Resource Name (URN) associated with the first resource and to determine the resource locator based on the URN.

21. The system of claim 19 wherein the resource locator is a Uniform Resource Locator (URL) and the URRA includes at least a portion of the URL.

22. The system of claim 21 wherein the URL for the first resource is a Uniform Resource Name (URN) identifying the second resource and not identifying a location of the second resource.

23. The system of claim 19 wherein the content manager component is configured to determine a network address of a node configured to route the message to the related resource service hosted by a node representing a service domain at least partially including the resource domain identifier, wherein the determined network address is at least one of provided in configuration data of a sending node, received from user input, received in a resource, received when the URRA is generated, received from a remote node in response to a request, and generated based on at least one of a configured template, an identifier of a schema of the second resource, an identifier of a resource, and an accessor of the second resource.

24. The system of claim 23 wherein the domain identified in the URRA is not included in any network identifier of any network interface of the node configured to route the message.

25. The system of claim 19 wherein the content handler component is further configured to receive, from the related resource service, a response including one of the second resource and an accessor for accessing the second resource.

26. A system for providing access to resources related to a locatable resource, the system comprising system components including:
a routing layer component in a related resource service node (RRSN) representing a service domain, the routing layer configured to receive a message including a Uniform Related Resource Accessor (URRA) including a resource domain identifier, which identifies a resource domain of a resource provider of a first resource, and identifying an association between a second resource and the resource domain;
a domain manager component configured to determine whether the resource domain identified by the resource domain identifier in the URRA is at least partially included in the service domain represented by the RRSN; and
a processing agent component configured to process the message when the resource domain is determined to be at least partially included in the service domain, the processing including providing access to the second resource,
wherein at least one of the system components includes at least one electronic hardware component.

27. The system of claim 26 wherein the resource domain identifier comprises one of a name in a naming domain space and a subnet identifier in a network address domain space, and wherein the domain manager component is configured to map the resource domain identifier to a domain space corresponding to the domain space of the service domain and to compare the mapped resource domain identifier to the service domain.

28. The system of claim 26 wherein the processing agent component is configured to at least one of locate a storage area for storing a new association between the second resource and the resource domain, read the second resource, update at least a portion of the second resource, and delete at least a portion of the second resource.

29. The system of claim 26 wherein the processing agent component is configured to at least one of receive at least a portion of the second resource, and receive a second resource locator for accessing the second resource.

30. The system of claim 29 further comprising a message generator component configured to generate a response message including at least one of the second resource locator and the at least a portion of the second resource and to send the response message to a receiving node, wherein the receiving node is a node from which the message including the URRA was received.

31. The system of claim 26 further comprising a message generator component configured to generate a second message including at least a portion of the URRA, and to send the second message for routing to a second RRSN representing a second service domain when the resource domain is determined not to be at least partially included in the service domain.

32. The system of claim 31 wherein the message generator component is configured to determine a network address of a node configured to route the second message to the second RRSN, wherein the determined network address is at least one of provided in configuration data of the sending RRSN, received with the message, received from a resolver service in response to a request, and generated based on at least one of the accessor of the second resource, the identifier of the first resource, and the identifier of the resource domain.
